(19) United States
(12) Patent Application Publication
(10) Pub. No.: US 2025/0217641 A1
(43) Pub. Date: Jul. 3, 2025

(54) MULTI-MODAL MIXTURE OF EXPERTS NEURAL NETWORKS

(71) Applicant: Google LLC, Mountain View, CA (US)

(72) Inventors: Basil Mustafa, Zurich (CH); Carlos Riquelme Ruiz, Zurich (CH); Joan Puigcerver i Perez, Zurich (CH); Rodolphe Jenatton, Berlin (DE); Neil Matthew Tinmouth Houlsby, Zurich (CH)

(21) Appl. No.: 18/867,170

(22) PCT Filed: May 19, 2023
(86) PCT No.: PCT/US2023/022977

§ 371 Date: Nov. 19, 2024

Related U.S. Application Data
(60) Provisional application No. 63/344,036, filed on May 19, 2022.

(51) Int. Cl. G06N 3/08; G06F 18/241; G06N 3/045

(52) U.S. Cl. CPC G06N 3/08; G06F 18/241; G06N 3/045

(57) ABSTRACT

Methods, systems, and apparatus, including computer programs encoded on a computer storage medium, for performing a multi-modal machine learning task using a neural network. In one aspect, a method comprises, receiving a request to perform a machine learning task on an input tuple comprising a first network input in a first modality and a second network input in a second modality; processing the first network input to generate a first embedded sequence; processing the second network input to generate a second embedded sequence; processing the first embedded sequence and the second embedded sequence using an attention neural network to generate an updated first embedded sequence and an updated second embedded sequence; and processing the updated first embedded sequence and the updated second embedded sequence to generate a final representation for the first network input and a final representation for the second network input.

### CROSS-REFERENCE TO RELATED APPLICATION

This application claims priority to U.S. Provisional Application No. 63/344,036, filed on May 19, 2022. The disclosure of the prior application is considered part of and is incorporated by reference in the disclosure of this application.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains and uses a neural network to perform a multi-modal machine learning task. A multi-modal machine learning task is a task that requires the neural network to process an input that includes data from two or more modalities in order to generate the output for the task.

According to an aspect, there is provided a computer-implemented method comprising receiving a request to perform a machine learning task on an input tuple comprising a first network input in a first modality and a second network input in a second modality to generate a network output for the machine learning task; processing the first network input to generate a first embedded sequence comprising a respective token at each of one or more positions in the first embedded sequence; processing the second network input to generate a second embedded sequence comprising a respective token at each of one or more positions in the second embedded sequence; processing the first embedded sequence and the second embedded sequence using an attention neural network having multiple attention layers to generate an updated first embedded sequence and an updated second embedded sequence, wherein each attention layer in the attention neural network is configured to update the respective token at each of the one or more positions in the first or second embedded sequence at least in part by applying a self-attention mechanism over the embedded sequence; and processing the updated first embedded sequence and the updated second embedded sequence to generate a final representation for the first network input in the first modality and a final representation for the second network input in the second modality.

The method may further comprise processing the final representation for the first network input and the final representation for the second network input using an output neural network to generate the network output for the machine learning task.

The first network input may comprise image data and the second network input comprises text data.

The input tuple may comprise a third network input in a third modality.

The third network input may comprise audio data.

The machine learning task may comprise an image classification task, wherein the first network input may comprise an image and the second network input comprises text describing a set of object categories, and wherein the network output may comprise a respective score for each of the set of object categories representing an estimated likelihood that the image contains an image of an object belonging to the category.

At least one attention layer in the attention neural network may be a Mixture of Experts (MoE) attention layer, the MoE attention layer may comprise: an attention sub-layer configured to: receive an input sequence for the MoE attention layer comprising a respective layer input at each of one or more layer positions; and generate an attended input sequence at least in part by applying an attention mechanism to the input sequence for the MoE attention layer, the attended input sequence comprising a respective attended layer input at each of the one or more layer positions; one or more learned routing functions; and a plurality of expert neural networks each having a respective set of expert parameters, and wherein the MoE attention layer is configured to, for each of the one or more layer positions: apply at least one of the one or more learned routing functions in the MoE attention layer to the attended layer input at the layer position to generate a respective score distribution that includes a respective routing score for each of the plurality of expert neural networks in the MoE attention layer, select, from the plurality of expert neural networks, one or more expert neural networks having the highest routing scores, and process the attended layer input at the layer position using only each selected expert neural network and in accordance with current values of the expert parameters of the selected expert neural network to generate an expert network output for the attended layer input at the layer position.

The MoE attention layer may further be configured to generate an output sequence of the MoE attention layer, comprising, for each of the one or more layer positions, computing a product of the routing score for each selected expert neural network and the expert network output generated by the selected expert neural network

The expert neural networks may be a respective multi-layer perceptron neural network.

The MoE attention layer may comprise a first learned routing function and a second learned routing function having learned routing parameter values that are different from each other, wherein the first learned routing function is applied only to an attended input sequence generated from the first network input in the first modality, and wherein the second learned routing function is applied only to an attended input sequence generated from the second network input in the second modality.

Each MoE layer may comprise one learned routing function that is applied to an attended input sequence generated from either the first network input in the first modality or the second network input in the second modality

Each expert neural network in the MoE attention layer may be configured to process at most a fixed number of attended layer inputs, the fixed number being dependent on a buffer capacity of the expert neural network

Processing the first network input to generate the first embedded sequence may comprise: selecting a modality-specific embedding engine that corresponds to the first modality from a plurality of modality-specific embedding engines that correspond respectively to different modalities.

The plurality of modality-specific embedding engines may comprise a patch-based image embedding engine and a vocabulary-based text embedding engine.

Processing the updated first embedded sequence to generate the final representation for the first network input may comprise: combining respective updated tokens at each of the one or more positions in the first embedded sequence to generate the final representation for the first network input.

Combining the respective updated tokens may comprise: applying an average pooling function the respective updated tokens at each of the one or more positions in the first embedded sequence.

According to another aspect, there is provided a method of training the attention neural network of the above aspect, the method comprising: processing, using the attention neural network and in accordance with current values of attention network parameters, one or more training tuples that each include an image training input and a text training input to generate, for each training tuple, a training final representation tuple that includes a training final image representation and a training final text representation; determining a gradient with respect to the attention network parameters of a loss function that includes a contrastive learning loss term that (i) encourages similarity between training final image representations and training final text representations in a same final representation tuple and that (ii) discourages similarity between training final image representations and training final text representations that are from different final representation tuples; and determining, based on the gradient of the contrastive learning objective function, an update to the current values of the attention network parameters.

The loss function may include a local entropy loss term that encourages the routing function to generate score distributions that include fewer scores that are greater than a certain threshold

The loss function may include a global entropy loss term that encourages the routing function to generate score distributions that include more scores that are greater than a certain threshold

The loss function may include one local entropy loss and one global entropy loss for each modality of data included in the training tuple

According to yet another aspect, there is provided one or more computer-readable storage media encoded with instructions that, when executed by one or more computers, cause the one or more computers to perform the operations of the above method aspect.

According to a further aspect, there is provided a system comprising one or more computers and one or more storage devices storing instructions that when executed by one or more computers cause the one or more computers to perform the respective operations of the above method aspect.

The subject matter described in this specification can be implemented in particular embodiments so as to realize one or more of the following advantages. A multi-modal neural network, as described in this specification, is a single machine learning model that can achieve high levels of performance on one or more machine learning tasks spanning multiple data modalities. The described multi-modal neural network combines different mechanisms from different machine learning domains, e.g., modality-specific data embedding techniques, attention mechanisms, and sparsely gated mixture of experts layers, to enhance the performance of the multi-modal neural network. Advantageously, and unlike previous approaches, the multi-modal neural network can be trained by using an entropy-based regularization scheme which enhances training stability and encourages balanced expert utilization, thus improving the efficiency of the training process, while yielding better performance on a range of multi-modal tasks than previous approaches.

Furthermore, in some implementations, a multi-modal neural network can account for a fixed buffer capacity and/or memory constraint on which the system is deployed by configuring mixture of experts sublayers of the multi-modal neural network to process at most a fixed number of attended layer inputs. Additionally, the mixture of experts sublayers can be configured to operate in parallel for enhanced computational efficiency.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 is a flow diagram of an example process for performing a machine learning task on an input tuple to generate a network output.

FIG. 3 is a flow diagram of an example process for generating an attended input sequence from an input sequence for a MoE attention layer.

FIG. 4 is a flow diagram of an example process for generating an output sequence for a MoE attention layer.

FIG. 5 is a flow diagram of an example process for training an attention neural network.

Like reference numbers and designations in the various drawings indicate like elements.

### DETAILED DESCRIPTION

This specification describes systems implemented as computer programs on one or more computers in one or more locations that trains and uses a neural network to perform a multi-modal machine learning task. A multi-modal machine learning task is a task that requires the neural network to process an input that includes data from two or more modalities in order to generate the output for the task.

In some cases, the task is a multi-modal understanding task. For example, the task can be a visual question answering task that requires generating an answer to a question that is posed about a visual input. As another example, the task can be an open-vocabulary image classification task, where the neural network is configured to receive an input tuple including an image and a natural language sequence for the image, which may be a sequence of words in a target natural language that describes the image, and to process the network input to generate a classification output that specifies whether the natural language sequence includes an accurate description for the image. As another example, the task can be an open-vocabulary object detection task, where the neural network is configured to receive an input tuple including an image and text describing a set of object categories, and to process the network input to generate a network output that includes a respective score for each of the set of object categories representing an estimated likelihood that the image contains an image of an object belonging to the category. Further examples of the multi-modal understanding task include image captioning, text-based image search, image-based retrieval, and so on.

In some other cases, the task can be a health-related task to make predictions about the health of a patient from multi-modal data relating to the patient, e.g., to predict the likelihood of one or more health events occurring to the patient in some future time period, to predict a treatment that should be prescribed to the patient, or to predict a diagnosis for the patient.

The multiple modalities can include multiple different feature modalities from the electronic health record of the patient. In particular, the multiple different feature modalities can include two or more of (1) contextual features, such as patient age and sex; (2) longitudinal categorical features, such as procedure codes, medication codes, and condition codes; (3) longitudinal continuous features, such as blood pressure, body temperature, and heart rate; and (4) longitudinal free-text clinical notes, which are often lengthy and contain a lot of medical terminology.

These data types differ not only in feature spaces and dimensionalities, but also in data generation processes and measurement frequencies. For example, lab tests and procedures are ordered at the physician's discretion and therefore occur at irregular frequencies in the electronic health record, while blood pressure and body temperature can be monitored on a regular basis.

Instead of or in addition to one or more modalities from the electronic health record, the multiple modalities can also include any of: medical imaging data for the patient, genomics data for the patient, or speech waveform or other audio waveform data that is relevant to the patient.

In some other cases, the task is a task that requires processing audio data of a person speaking and corresponding video. That is, one modality is audio data and the other data is the corresponding video data. Examples of such tasks include audio-visual speech recognition and visual question-answering.

In yet other cases, the task is a content recommendation task that requires processing data from multiple feature modalities to make a recommendation of one or more content items to be presented to a user. The feature modalities can include two or more of: content data characterizing the content item currently being presented to the user, meta data for the content data, or history data characterizing previous content items that have been previously presented to the user and, optionally, data characterizing the interaction of the user with the previously presented content items.

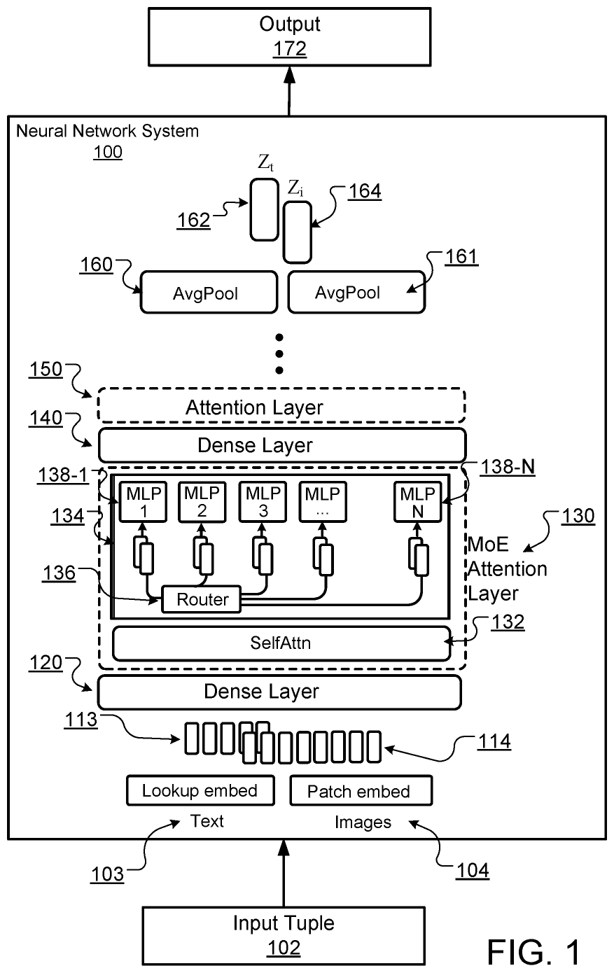

FIG. 1 shows an example neural network system 100. The neural network system 100 is an example of a system implemented as computer programs on one or more computers in one or more locations, in which the systems, components, and techniques described below can be implemented.

The neural network system 100 includes an attention-based, multi-modal mixture of experts (MoE) neural network, or an “attention neural network” for short, that has been configured through training to process an input tuple 102 and to perform any of a variety of multi-modal machine learning tasks on the input 102 to generate an output 172. The input tuple 102 can include multiple network inputs from different modalities.

In this specification, a “modality” characterizes a mode by which data can be represented, and can define a class of network inputs that each represent data according to the mode. For example, the multiple modalities can include a “text” modality, where the network inputs corresponding to the text modality include or represent one or more text sequences. As another example, the multiple modalities can include an “image” modality, where the network inputs corresponding to the image modality include or represent one or more images. As another example, the multiple modalities can include a “video” modality, where the network inputs corresponding to the video modality include or represent one or more videos. As yet another example, the multiple modalities can include an “audio” modality, where the network inputs corresponding to the audio modality include or represent one or more audio samples.

To accommodate the network inputs which include data from the different modalities, the attention neural network includes multiple modality-specific embedding engines, i.e., one embedding engine corresponding to each modality. Each embedding engine includes software that is configured to process the network input corresponding to the modality of the embedding engine to generate an embedded sequence that includes a respective token at each of multiple positions in the embedded sequence.

In this specification, a “token” can refer to, e.g., a numerical value (e.g., an integer or floating point numerical value) or an embedding. An embedding refers to an ordered collection of numerical values, e.g., a vector, matrix, or other tensor of numerical values. More generally, a “token” can refer to any layer output at a layer position within an output sequence generated by an intermediate neural network layer.

The embedding engines can represent a network input as an embedded sequence in any appropriate way. As illustrated in FIG. 1, to generate an embedded sequence 113 for a sequence of text 103 included in a network input, the embedding engine corresponding to the text modality can represent the sequence of text 103 as a sequence of vocabulary tokens selected (or, “looked up”) from a predefined set of vocabulary tokens, and then map each vocabulary token to a corresponding numerical value in accordance with a predefined mapping. The set of vocabulary tokens can include, e.g., characters, n-grams, word pieces, words, or a combination thereof.

For a network input that includes an image 104, the embedding engine corresponding to the image modality can divide the image into a sequence of patches, and then generate a respective embedding of each patch using an encoder neural network. The embedding engine can then concatenate the respective embeddings of the image patches to generate a representation of the image 104 as an embedded sequence 114. The encoder neural network, which is either included within or accessible by the embedding engine, can be implemented as a neural network having any appropriate neural network architecture. By way of illustration and not limitation, the encoder neural network can be one of the neural networks described in Alexey Dosovitskiy, et at. An image is worth 16×16 words: Transformers for image recognition at scale. ICLR, 2021.

The embedded sequences generated by the embedding engines are then provided to a shared backbone that includes a stack of multiple dense layers and multiple attention layers included in the attention neural network. The multiple dense layers and multiple attention layers are configured to update the embedded sequences by passing data between them in a certain layer order. Unlike the embeddings engines which are modality-specific, the dense layers and the attention layers are modality-agnostic, i.e., the same dense layers and the same attention layers will be used to process different embedded sequences generated from multiple modalities.

Each dense layer includes one or more fully-connected layers with, e.g., a ReLU or GeLU activation function, that are configured to process an input sequence for the dense layer to generate a transformed input sequence. Each attention layer includes a self-attention sub-layer and a feed-forward sub-layer. The self-attention sub-layer receives the input sequence for the attention layer, which can be the output sequence of a preceding layer, e.g., the transformed input sequence generated by a dense layer, and applies an attention mechanism on the input sequence for the attention layer to generate an attended input sequence that includes an attended layer input at each of multiple positions in the attended input sequence.

Generally, to apply the attention mechanism, the self-attention sub-layer uses one or more attention heads. Each attention head generates a set of queries, a set of keys, and a set of values, and then applies any of a variety of variants of query-key-value (QKV) attention using the queries, keys, and values to generate an output. When there are multiple attention heads, the self-attention sub-layer then combines the outputs of the multiple attention heads, e.g., by concatenating the outputs and, optionally, processing the concatenated outputs through a linear layer.

Examples of QKV attention variants are described in Vaswani, et al, Attention Is All You Need, arXiv:1706.03762, Raffel, et al, Exploring the Limits of Transfer Learning with a Unified Text-to-Text Transformer, arXiv:1910.10683, Devlin et al, BERT: Pre-training of Deep Bidirectional Transformers for Language Understanding, arXiv:1810.04805, Dai, et al, Transformer-XL: Attentive Language Models Beyond a Fixed-Length Context, arXiv:1901.02860, and Kitaev, et al, Reformer: The Efficient Transformer, arXiv: 2001.04451, the entire contents of which are hereby incorporated by reference herein in their entirety.

In some cases, the attended input sequence is the final output of the attention mechanism. In some other cases, the self-attention sub-layer applies one or more other operations, e.g., residual connections, layer normalization, or both, to the final output to generate the sequence.

The feed-forward sub-layer then operates on the attended input sequence to generate an output sequence for the attention layer. In some implementations, the feed-forward sub-layer includes a multi-layer perceptron (MLP) that operates on each position in the attended input sequence separately, i.e., in a position-wise manner. The MLP can include multiple, i.e., two or more, fully-connected layers with, e.g., a ReLU or GeLU activation function.

In particular, for some of the attention layers in the attention neural network, the feed-forward sub-layer is a MoE sub-layer that also operates in a position-wise matter, but, instead of processing each attended layer input using the same MLP, maintains multiple expert neural networks 138-1-138-N and uses different expert neural networks to process the attended layer inputs at different positions. In this specification, those kinds of attention layers will be referred to as mixture of experts (MoE) attention layers.

FIG. 1 thus illustrates that the attention neural network includes a dense layer 120, followed by a MoE attention layer 130 that includes a self-attention sub-layer 132 and a MoE sub-layer 134, followed by another dense layer 140, followed by an attention layer 150 that includes a self-attention sub-layer and a feed-forward sub-layer. Although only one MoE attention layer and one attention layer are shown in FIG. 1 for convenience, the neural network generally includes many more attention layers, MoE attention layers, or both.

Each expert neural network generally has the same architecture, but has different values of network parameters (“expert parameters”) as a result of the training of the neural network. For example, each expert neural network, e.g., expert neural network 138-1, can be a respective MLP that includes multiple, i.e., two or more, fully-connected layers with, e.g., a ReLU or GeLU activation function.

For each attended layer input, the MoE sub-layer 134 applies a learned routing function 136 to generate a respective routing score for each of the multiple expert neural networks 138-1-138-N. As used in this specification, the term “learned” means that an operation or a value has been adjusted during the training of the neural network.

Generally, a routing function 136 is a function that has learned parameters and that maps an attended layer input for a position to the respective routing scores in accordance with the learned parameters. As a particular example, the routing function 136 can generate a respective initial score for each expert neural network by computing a dot product between a learned vector for the expert neural network and the attended layer input for the position and then compute the routing scores by applying a softmax function to the initial scores.

For each attended layer input, the MoE sub-layer 134 then selects, from the multiple expert neural networks 138-1-138-N, a proper subset based at least on the respective routing scores. For each attended layer input, the MoE sub-layer 134 then uses only the expert neural network(s) in the proper subset, i.e., and not using any of the expert neural networks that are not in the proper subset, to process the attended layer input, data derived from the attended layer input, or both to generate a respective expert network output.

The MoE sub-layer 134 then combines the respective expert network outputs to generate a combined expert output for the attended layer input. In some implementations, the MoE sub-layer 134 can compute a weighted sum of the respective expert network outputs, with each expert network output weighted by the routing score for the selected expert neural network that generated the expert output. Thus, the final output of the MoE sub-layer 134 includes a combined expert network output for each attended layer input included in the attended input sequence. The final output sequence of the MoE sub-layer 134 can then be provided as input sequence to the dense layer 140 for further processing.

In other words, for any given attended layer input, the MoE sub-layer 134 will always select and use only a proper subset of the expert neural networks in the MoE sub-layer to generate the final output sequence of the MoE attention layer 130. Thus, the MoE sub-layer 134 performs conditional computation, i.e., performs different operations for different attended layer inputs.

In particular, the MoE sub-layer 134 selects at most k of the E expert neural networks to be in the proper subset, with k being a positive integer that is small relative to the total number of expert neural networks E. For example, the MoE sub-layer 134 can select the top k expert neural networks, i.e., the k expert neural networks with the highest routing scores, as the expert neural networks in the proper subset. As a particular example, k is equal to 1 or another small integer less than five, while E is equal to 32, 64, or another integer greater than that.

In some implementations, the MoE sub-layer 134 includes only one routing function 136 as a joint routing function for all of the multiple expert neural networks 138-1-138-N. In these implementations, the MoE sub-layer 134 uses the same routing function 136 to select, from all of the multiple expert neural networks, the k expert neural networks for attended input sequences generated from input data in different modalities. In some other implementations, the routing function 136 is a per-modality routing function, and the MoE sub-layer 134 maintains one routing function for each data modality. In some of those implementations, different per-modality routing functions can be used to select expert neural networks from different, non-overlapping groups of the multiple expert neural networks 138-1-138-N.

For example, the MoE sub-layer 134 can include (i) a text modality routing function that is used to select, from a first group of expert neural networks 138-1-138-M, the k expert neural networks for each attended layer input included in an attended input sequence generated (by preceding components of the attention neural network) from a sequence of text 103, and (ii) an image modality routing function that is used to select, from a second group of expert neural networks 138-M-138-N, the k expert neural networks for each attended layer input included in an attended input sequence generated from an image 104.

In some implementations, each expert neural network in the MoE sub-layer 134 is configured to process at most a fixed number of attended layer inputs. This fixed number can be a number that is predetermined prior to inference time. e.g., based on the buffer capacity of the expert neural network or the memory constraint of the hardware on which the system is deployed. At inference time, if a given expert neural network is selected to process more than the fixed number of attended layer inputs, those extra attended layer inputs are “dropped”; they are not processed by the selected expert neural network, and the expert outputs will be all zeros for those extra attended layer inputs.

In some implementations, the expert neural networks in the MoE sub-layer 134 are configured to process their respective attended inputs in parallel.

As illustrated in FIG. 1, the attention neural network includes multiple modality-specific pooling layers 160, 161, i.e., one pooling layer corresponding to each modality, that are arranged atop the shared backbone. To generate the final representation for each network input included in the input tuple 102, the pooling layer that corresponds to the modality of the data included in the network input can apply, e.g., a maximal, minimal, or average pooling function, to combine the updated token at each of the multiple positions in the updated embedded sequence that has been generated by the last layer in the shared backbone for the network input. Thus, FIG. 1 illustrates that the pooling layer 160 generates one or more final representations Zₜ 162 for the sequence of text 103 included in the first network input, and another pooling layer 161 generates one or more final representations Zᵢ 164 for the image 104 included in the second network input.

The attention neural network also includes an output neural network. The output neural network includes a stack of one or more layers that are configured to process the final representations of the network inputs included in the input tuple 102 to generate the network output 172 for the multi-modal machine learning task. The output neural network can be implemented as a neural network having any appropriate neural network architecture.

In some implementations, the output neural network can include one or more fully-connected layers that are configured to process the one or more final representations Zₜ 162 for the sequence of text 103 to generate one or more first dense vectors and to process the one or more final representations Zᵢ 164 for the image 104 to generate one or more second dense vectors. The output neural network (or another component) of the neural network system 100 can then generate the output 172 based on the similarity between the first and second dense vectors. For example, when the task is a classification task, the system can determine a similarity measure between a second dense vector generated for the image 104 and each of the multiple first dense vectors that have been generated for different text items included in the sequence of text 103 that each represent a distinct object category. The system can then select, from among all first dense vectors that have been generated, a particular first dense vector that is most similar to the second dense vector and then determine the predicted object category of the image 104 according to the text item based on which the particular first dense vector was generated. Here, the “similarity measure” is defined in terms of a distance in the embedding space. The distance may be computed in any appropriate way, such as with Euclidean distance, Hamming distance, cosine similarity, to name just a few examples.

Like the pooling layers, in some implementations, the layers included in the output neural network are modality-specific. Thus output neural network includes different stacks of layers, where each stack is configured to receive only the final representation of the network input that includes data having the corresponding modality. In other implementations, the layers included in the output neural network are modality-agnostic, such that the output neural network uses the same stack of layers to process the final representation of any network input included in the input tuple 102.

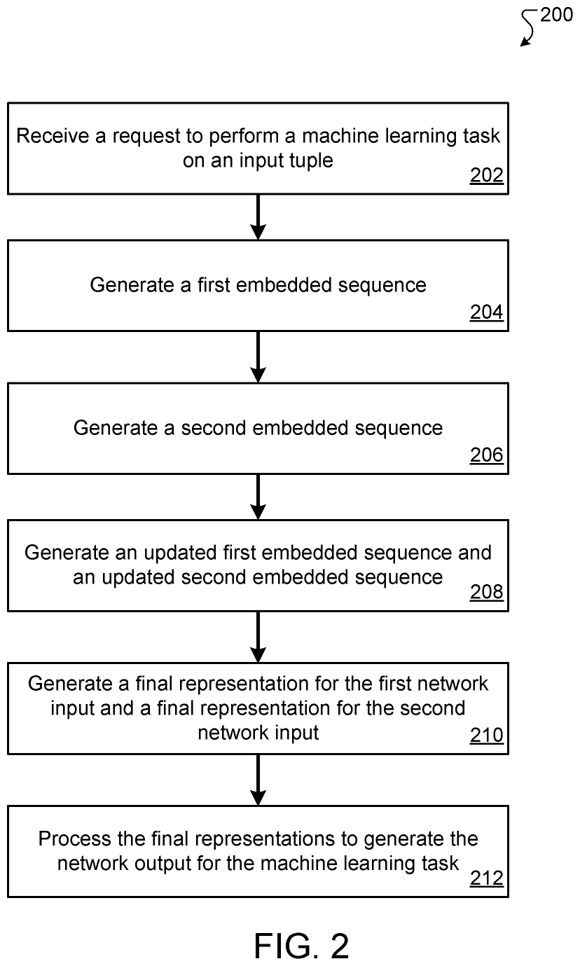

FIG. 2 is a flow diagram of an example process 200 for performing a machine learning task on an input tuple to generate a network output. For convenience, the process 200 will be described as being performed by a system of one or more computers located in one or more locations. For example, a neural network system, e.g., neural network system 100 of FIG. 1, appropriately programmed in accordance with this specification, can perform the process 200.

The system receives a request to perform a machine learning task on an input tuple that includes a first network input in a first modality and a second network input in a second modality to generate a network output for the machine learning task (step 202). For example, the first network input can include image data, and the second network input can include text data.

The system processes the first network input to generate a first embedded sequence that includes a respective token at each of one or more positions in the first embedded sequence (step 204). The system includes or has access to a plurality of modality-specific embedding engines that correspond respectively to different modalities, from which a modality-specific embedding engine that corresponds to the first modality can be selected. When the first modality is text modality, to generate the first embedded sequence, the system can select and use a vocabulary-based text embedding engine. The vocabulary-based text embedding engine represents a sequence of text included in the first network input as a sequence of vocabulary tokens from a predefined set of vocabulary tokens, and then maps each vocabulary token to a corresponding numerical value in accordance with a predefined mapping.

The system processes the second network input to generate a second embedded sequence that includes a respective token at each of one or more positions in the second embedded sequence (step 206). When the second modality is image modality, to generate the second embedded sequence, the system can select and use a patch-based image embedding engine. The patch-based image embedding engine divides the image included in the second network input into a sequence of patches, and then generate a respective embedding of each patch using an encoder neural network. The patch-based image embedding engine can then concatenate the respective embeddings of the image patches to generate a representation of the image as an embedded sequence.

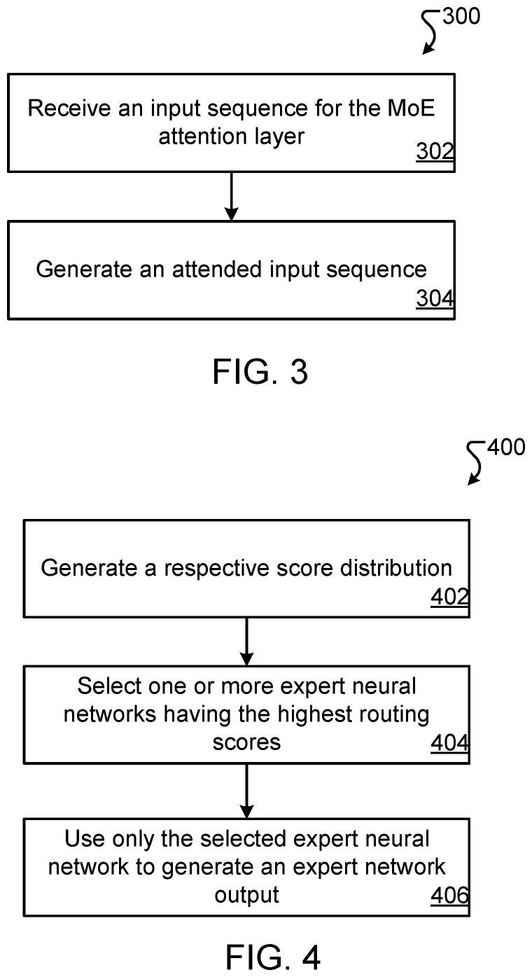

The system processes the first embedded sequence and the second embedded sequence using an attention neural network having multiple attention layers to generate an updated first embedded sequence and an updated second embedded sequence (step 208). Each attention layer in the attention neural network is configured to update the respective token at each of the one or more positions in the first or second embedded sequence at least in part by applying a self-attention mechanism over the embedded sequence. More details of the operations performed by the attention neural network will be described with reference to FIGS. 3-4.

The system processes the updated first embedded sequence and the updated second embedded sequence to generate a final representation for the first network input in the first modality and a final representation for the second network input in the second modality (step 210). The updated first (or second) embedded sequence includes a respective updated token at each of the one or more positions in the first (or second) embedded sequence. Thus, the system can generate the final representation for the first (or second) network input by applying a pooling function to the updated first (or second) embedded sequence to combine the respective updated tokens within the updated first (or second) embedded sequence. The pooling function can be modality-specific, and the system can apply different pooling functions to the updated first and second embedded sequences.

In principle the system can repeatedly perform each of steps 204-210 to generate multiple embedded sequences, multiple updated embedded sequences, and multiple final representations for the same input in the same modality. For example, when the second network input includes a sequence of text, the system can generate one final representation for each distinct sub-sequence of the text included in the second network input.

The system processes the one or more final representations for the first network input and the one or more final representations for the second network input using an output neural network to generate the network output for the machine learning task (step 212). The output neural network, which is included as part of the attention neural network, can have any appropriate neural network architecture that can be configured to map the final representations to the network output for the machine learning task.

Performing a multi-modal machine learning task on data from two modalities has now been described. In various cases, however, the input tuple can include additional network inputs that includes data in a greater number of modalities. For example, the input tuple can include a third network input in a third modality, e.g., audio modality. It will be appreciated that in such examples, the system can be similarly configured to process the first, second, and the third network inputs to generate a network output for the task from these network inputs, which include data from text, image, and audio modalities, respectively.

FIG. 3 is a flow diagram of an example process 300 for generating an attended input sequence from an input sequence for a MoE attention layer. For convenience, the process 300 will be described as being performed by a system of one or more computers located in one or more locations. For example, a neural network system, e.g., neural network system 100 of FIG. 1, appropriately programmed in accordance with this specification, can perform the process 300.

In general, the system can perform process 300 at each mixture of experts (MoE) attention layer included in the attention neural network.

The system receives an input sequence for the MoE attention layer that includes a respective layer input (or, token) at each of one or more layer positions (step 302). For example, the input sequence can be an embedded sequence of the network input, an output sequence generated by the preceding layer, e.g., the transformed input sequence generated by a dense layer, in the neural network, depending on the configuration of the attention neural network and the position of the MoE attention layer within the neural network.

The system generates an attended input sequence at least in part by processing the input sequence using a self-attention sub-layer included in the MoE attention layer (step 304). The self-attention sub-layer is configured to generate an attended input sequence that includes a respective attended layer input at each of the one or more layer positions at least in part by applying an attention mechanism to the input sequence for the MoE attention layer.

FIG. 4 is a flow diagram of an example process 400 for generate an output sequence for a MoE attention layer. For convenience, the process 400 will be described as being performed by a system of one or more computers located in one or more locations. For example, a neural network system, e.g., neural network system 100 of FIG. 1, appropriately programmed in accordance with this specification, can perform the process 400.

In general, the system can perform process 400 at each mixture of experts (MoE) attention layer included in the attention neural network, e.g., after having performed process 300 to generate the attended input sequence. In particular, the system can perform process 400 for the attended layer input at each layer position in the attended input sequence.

The system applies at least one of the one or more learned routing functions included in the MoE attention layer to the attended layer input at the layer position to generate a respective score distribution that includes a respective routing score for each of the plurality of expert neural networks in the MoE attention layer (step 402). As described above, the routing function is a function that has learned parameters and that maps an attended layer input to the respective routing scores in accordance with the learned parameters.

In some implementations, the MoE attention layer includes one joint routing function that is applied to the attended layer input included in an attended input sequence that has been generated from either the first network input in the first modality or the second network input in the second modality.

In other implementations, the MoE attention layer includes multiple per-modality routing functions having learned routing parameter values that are different from each other. For example, the MoE attention layer can include a first learned routing function and a second learned routing function, where the first learned routing function is applied only to an attended input sequence generated from the first network input in the first modality, and the second learned routing function is applied only to an attended input sequence generated from the second network input in the second modality.

The system selects, from the plurality of expert neural networks, one or more expert neural networks having the highest routing scores (step 404). Generally, the system selects at most k of the E experts, with k being a positive integer that is small relative to the total number of experts E. For example, k is equal to 1, while E is a positive integer no less than 32.

The system processes the attended layer input at the layer position using only each selected expert neural network and in accordance with current values of the expert parameters of the selected expert neural network to generate an expert network output for the attended layer input at the layer position (step 406). When more than one expert neural network is selected, the system combines the respective expert network outputs to generate a combined expert network output for the attended layer input at the layer position. For example, the system can compute a weighted sum of the respective expert network outputs weighted by the routing scores, namely by computing a product of the routing score for each selected expert neural network and the expert network output generated by the selected expert neural network, and then summing the products.

For each MoE attention layer in the attention neural network, the system can repeatedly (i.e., at each of one or more MoE attention layers included in the attention neural network) perform the processes 300 and 400 to update the input sequence to the MoE attention layer to generate an updated input sequence and then provide the updated input sequence to a subsequent layer. In particular, the updated input sequence will include the combined expert network output that has been generated for each of the one or more layer positions of an input sequence for the MoE attention layer. When the MoE attention layer is the last layer in the shared backbone, the system can then use the updated input sequence to a pooling layer to generate a final representation, i.e., to be used in step 210 of process 200.

Prior to using the attention neural network to perform the task, the neural network system 100 or another training system trains the neural network on training data for the task, i.e., so that the neural network can effectively perform the task on data from multiple different modalities.

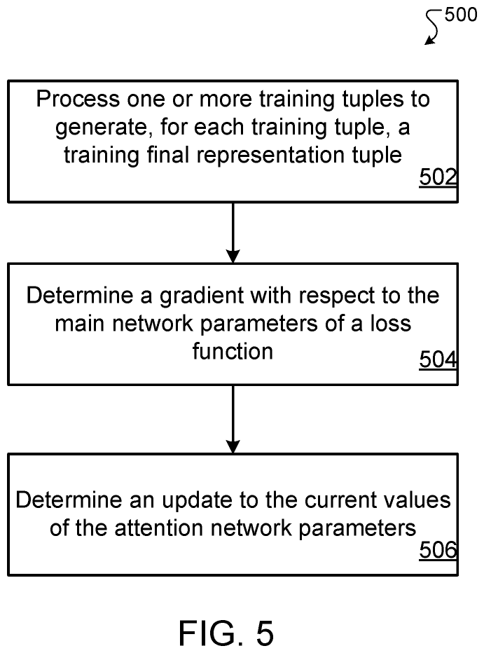

FIG. 5 is a flow diagram of an example process 500 for training an attention neural network. For convenience, the process 500 will be described as being performed by a system of one or more computers located in one or more locations. For example, a neural network system, e.g., neural network system 100 of FIG. 1 or another training system, appropriately programmed in accordance with this specification, can perform the process 500.

The system can repeatedly perform iterations of process 500 on different batches of training tuples to update the values of the trainable parameters of the attention neural network, i.e., the parameters of the neural network layers and the routing functions.

The system can continue performing iterations of process 500 until termination criteria for the training of the attention neural network have been satisfied, e.g., until the parameters have converged, until a threshold amount of wall clock time has elapsed, or until a threshold number of iterations of the process 500 have been performed.

The system processes, using the attention neural network and in accordance with current values of attention neural network parameters, one or more training tuples that each include an image training input and a text training input to generate, for each training tuple, a training final representation tuple that includes a training final image representation and a training final text representation (step 502). As described above, the final image (or text) representation can be generated by a applying a pooling function to an updated embedded sequence that has been generated by the shared backbone from an embedded sequence of the image (or text) training input.

The system determines, e.g., through backpropagation, a gradient of a multi-modal contrastive learning loss function with respect to the attention neural network parameters (step 504). The loss function includes a contrastive learning loss term that (i) encourages similarity between training final image representations and training final text representations in a same final representation tuple and that (ii) discourages similarity between training final image representations and training final text representations that are from different final representation tuples. The loss function may comprise an image-to-text loss comparing the similarity of the training final image representation and training final text representation of a tuple to the similarity of the final image representation of the tuple and the training final text representations of other tuples. The loss function may comprise a text-to-image loss comparing the similarity of the training final image representation and training final text representation of a tuple to the similarity of the final text representation of the tuple and the training final image representations of other tuples. The loss function may be a weighted sum of the image-to-text loss and text-to-image loss.

By minimizing the loss function, the system thus pushes the representations generated for the image and text training inputs within the same training tuple closer together in an embedding space, i.e., reduces a distance between the representations in a same final representation tuple, while pushing the representations generated from image and text training inputs across different training tuples (within a same batch of training tuples sampled from a larger set of training tuples) apart in the embedding space.

The contrastive learning loss term can for example be computed as:

$${ℒ}_{j} ( {ℨ}_{n} ) = {\underbrace{- \frac{1}{2} log \frac{{e}^{( {z}_{{i}_{j}} , {z}_{{t}_{j}} ) / T}}{{\sum }_{k = 1}^{n} {e}^{( {z}_{{i}_{j}} , {z}_{{t}_{k}} ) / T}}}}_{image - to - text loss} {\underbrace{- \frac{1}{2} log \frac{{e}^{( {z}_{{i}_{j}} , {z}_{{t}_{j}} ) / T}}{{\sum }_{k = 1}^{n} {e}^{( {z}_{{i}_{k}} , {z}_{{t}_{j}} ) / T}}}}_{text - to - image loss} ,$$

where [symbol] ₙ={(zᵢ_{ⱼ},zₜ_{ⱼ})}ⱼ₌₁ⁿ, iⱼ represents an image training input, tⱼ and represents a text training input, Zᵢ represents a training final image representation, Zₜ represents a training final text representation, and T is the learned temperature value. The function <x, y> represents a metric between x and y, such as the cosine similarity between x and y.

An entropy-based regularization scheme can optionally be adopted by the system to ensure balanced expert utilization and to improve training stability. Therefore, in some implementations, the loss function also includes a local entropy loss term that encourages the routing function to generate score distributions that include fewer scores that are greater than a certain threshold. Put another way, the local entropy loss encourages a more concentrated routing score distribution across the plurality of expert neural networks, such that only a few of the expert neural networks are likely to be selected for processing the attended layer inputs.

In some other implementations, the loss function includes a global entropy loss term that encourages the routing function to generate score distributions that include more scores that are greater than a certain score value. Put another way, the global entropy loss encourages a more uniform routing score distribution across the plurality of expert neural networks, resulting in a more balanced usage of all expert neural networks for processing the attended layer inputs. In order to allow flexibility and to avoid distributional collapse, the global entropy loss may be thresholded, such that the routing function is encouraged to have a certain minimum entropy, but after exceeding that, the loss is not applied.

In yet other implementations, the loss function includes one local entropy loss and one global entropy loss as described above for each modality of data included in the training tuple.

The local and global entropy loss terms can for example be computed as:

$${Ω}_{local} ( {G}_{m} ) := \frac{1}{{n}_{m}} {\sum }_{i = 1}^{{n}_{m}} ℋ ( {p}_{m} ( experts \vert {x}_{i} ) ) and {Ω}_{global} ( {G}_{m} ) := - ℋ ( {\tilde{p}}_{m} ( experts ) )$$

where

$${\tilde{p}}_{m} ( experts ) = \frac{1}{{n}_{m}} {\sum }_{i = 1}^{{n}_{m}} {p}_{m} ( experts \vert {x}_{i} )$$

represents the expert probability distribution averaged over the tokens and [symbol] (p)=−Σₑ₌₁^{E}pₑ log(pₑ) represents the entropy. In each MoE attention layer, for each modality m, the routing function computes a routing score matrix Gₘ∈ [symbol] ⁿ^{ₘ}^{×E}. Each row of Gₘ represents the probability distribution over E expert neural networks for one of the nₘ tokens of that modality in the batch. For a token x that corresponding row is pₘ(experts|x)∈ [symbol] ^{E}; this is later used to select which expert neural network(s) to process x. Note that \tilde{p}ₘ(experts)≈pₘ(experts) since the true marginal is approximated from the tokens in the batch. Terminology local vs. global emphasizes the fact that Ω_{local} applies the entropy locally for each token while Ω_{global} at applies the entropy globally after having marginalized out the tokens.

The system determines, based on the gradient of the contrastive learning objective function, an update to the current values of the attention neural network parameters (step 506). In particular, the system updates the current values of the parameters of the neural network layers and, by virtue of backpropagation, the parameters of the routing functions. To update these parameter values based on the gradient, the system can apply any appropriate optimizer, e.g., an RMSprop, Adagrad, or Adam optimizer, to the gradient.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving a request to perform a machine learning task on an input tuple comprising a first network input in a first modality and a second network input in a second modality to generate a network output for the machine learning task;
processing the first network input to generate a first embedded sequence comprising a respective token at each of one or more positions in the first embedded sequence;
processing the second network input to generate a second embedded sequence comprising a respective token at each of one or more positions in the second embedded sequence;
processing the first embedded sequence and the second embedded sequence using an attention neural network having multiple attention layers to generate an updated first embedded sequence and an updated second embedded sequence, wherein each attention layer in the attention neural network is configured to update the respective token at each of the one or more positions in the first or second embedded sequence at least in part by applying a self-attention mechanism over the embedded sequence; and
processing the updated first embedded sequence and the updated second embedded sequence to generate a final representation for the first network input in the first modality and a final representation for the second network input in the second modality.

2. The method of claim 1, further comprising:
processing the final representation for the first network input and the final representation for the second network input using an output neural network to generate the network output for the machine learning task.

3. The system of claim 1, wherein the first network input comprises image data and the second network input comprises text data.

4. The system of claim 1, wherein the input tuple comprises a third network input in a third modality.

5. The method of claim 4, wherein the third network input comprises audio data.

6. The system of claim 1, wherein the machine learning task comprises an image classification task, wherein the first network input comprises an image and the second network input comprises text describing a set of object categories, and wherein the network output comprises a respective score for each of the set of object categories representing an estimated likelihood that the image contains an image of an object belonging to the category.

7. The method of claim 1, wherein at least one attention layer in the attention neural network is a Mixture of Experts (MoE) attention layer, the MoE attention layer comprising:
an attention sub-layer configured to:
receive an input sequence for the MoE attention layer comprising a respective layer input at each of one or more layer positions; and
generate an attended input sequence at least in part by applying an attention mechanism to the input sequence for the MoE attention layer, the attended input sequence comprising a respective attended layer input at each of the one or more layer positions;
one or more learned routing functions; and
a plurality of expert neural networks each having a respective set of expert parameters, and wherein the MoE attention layer is configured to, for each of the one or more layer positions:
apply at least one of the one or more learned routing functions in the MoE attention layer to the attended layer input at the layer position to generate a respective score distribution that includes a respective routing score for each of the plurality of expert neural networks in the MoE attention layer,
select, from the plurality of expert neural networks, one or more expert neural networks having the highest routing scores, and
process the attended layer input at the layer position using only each selected expert neural network and in accordance with current values of the expert parameters of the selected expert neural network to generate an expert network output for the attended layer input at the layer position.

8. The method of claim 7, wherein the MoE attention layer is further configured to generate an output sequence of the MoE attention layer, comprising, for each of the one or more layer positions, computing a product of the routing score for each selected expert neural network and the expert network output generated by the selected expert neural network.

9. The method of claim 7, wherein the expert neural networks is a respective multi-layer perceptron neural network.

10. The method of claim 7, wherein the MoE attention layer comprises a first learned routing function and a second learned routing function having learned routing parameter values that are different from each other, wherein the first learned routing function is applied only to an attended input sequence generated from the first network input in the first modality, and wherein the second learned routing function is applied only to an attended input sequence generated from the second network input in the second modality.

11. The method of claim 7, wherein each MoE layer comprises one learned routing function that is applied to an attended input sequence generated from either the first network input in the first modality or the second network input in the second modality.

12. The method of claim 7, wherein each expert neural network in the MoE attention layer is configured to process at most a fixed number of attended layer inputs, the fixed number being dependent on a buffer capacity of the expert neural network.

13. The method of claim 1, wherein processing the first network input to generate the first embedded sequence comprises:
selecting a modality-specific embedding engine that corresponds to the first modality from a plurality of modality-specific embedding engines that correspond respectively to different modalities.

14. The method of claim 13, wherein the plurality of modality-specific embedding engines comprises a patch-based image embedding engine and a vocabulary-based text embedding engine.

15. The method of claim 1, wherein processing the updated first embedded sequence to generate the final representation for the first network input comprises:
combining respective updated tokens at each of the one or more positions in the first embedded sequence to generate the final representation for the first network input.

16. The method of claim 15, wherein combining the respective updated tokens comprises:
applying an average pooling function the respective updated tokens at each of the one or more positions in the first embedded sequence.

17. (canceled)

18. (canceled)

19. The method of claim 7, wherein the attention neural network has been trained by performing training operations comprising
processing, using the attention neural network and in accordance with current values of attention network parameters, one or more training tuples that each include an image training input and a text training input to generate, for each training tuple, a training final representation tuple that includes a training final image representation and a training final text representation;
determining a gradient with respect to the attention network parameters of a loss function that includes a contrastive learning loss term that (i) encourages similarity between training final image representations and training final text representations in a same final representation tuple and that (ii) discourages similarity between training final image representations and training final text representations that are from different final representation tuples; and
determining, based on the gradient of the contrastive learning objective function, an update to the current values of the attention network parameters.

20. The method of claim 19, wherein the loss function includes a local entropy loss term that encourages the routing function to generate score distributions that include fewer scores that are greater than a certain threshold.

21. The method of claim 19, wherein the loss function includes a global entropy loss term that encourages the routing function to generate score distributions that include more scores that are greater than a certain threshold.

22. The method of claim 20, wherein the loss function includes one local entropy loss and one global entropy loss for each modality of data included in the training tuple.

23. (canceled)

24. A system comprising one or more computers and one or more storage devices storing instructions that when executed by the one or more computers cause the one or more computers to perform operations comprising:
receiving a request to perform a machine learning task on an input tuple comprising a first network input in a first modality and a second network input in a second modality to generate a network output for the machine learning task;
processing the first network input to generate a first embedded sequence comprising a respective token at each of one or more positions in the first embedded sequence;
processing the second network input to generate a second embedded sequence comprising a respective token at each of one or more positions in the second embedded sequence;
processing the first embedded sequence and the second embedded sequence using an attention neural network having multiple attention layers to generate an updated first embedded sequence and an updated second embedded sequence, wherein each attention layer in the attention neural network is configured to update the respective token at each of the one or more positions in the first or second embedded sequence at least in part by applying a self-attention mechanism over the embedded sequence; and
processing the updated first embedded sequence and the updated second embedded sequence to generate a final representation for the first network input in the first modality and a final representation for the second network input in the second modality.
